(19) United States
(12) Patent Application Publication
(10) Pub. No.: US 2016/0240287 A1
(43) Pub. Date: Aug. 18, 2016

(54) HINGED SPLIT BUSHING

(71) Applicant: Hubbell Incorporated, Shelton, CT (US)

(72) Inventors: JASON THOMAS, Mesa, AZ (US); Krzysztof Korcz, Grainger, IN (US)

(21) Appl. No.: 15/042,925

(22) Filed: Feb. 12, 2016

Related U.S. Application Data
(60) Provisional application No. 62/115,802, filed on Feb. 13, 2015.

(51) Int. Cl. H01B 17/26

(52) U.S. Cl. CPC H01B 17/26

(57) ABSTRACT

A hinged split bushing molded as a single part defining two semicircular arms separated by a hinge area that flexes closed. A clasp mechanism allows the bushing to be closed to a desired diameter. The bushing is molded in the open position as a unitary piece with a thin-wall area defining a triangular cutout area that allows the bushing to be bent into the closed position.

### CROSS-REFERENCE TO RELATED APPLICATIONS

This application claims the benefit of priority under 35 U.S.C. §119(e) to U.S. Provisional Application No. 62/115,802, filed Feb. 13, 2015, the entire contents of which are hereby incorporated by reference in their entirety.

### FIELD OF THE INVENTION

The present invention relates generally to split bushings for electrical conduits. More particularly, the present invention relates to hinged split bushings for electrical conduits including an integral tightening mechanism.

### BACKGROUND OF THE INVENTION

Bushings are known in the art. Bushings exist to cover the open end of an electrical conduit tube in order to protect the wires from becoming frayed or damaged from rubbing against the exposed edge of the conduit. This concern is particularly acute when dealing with thin-walled metal conduits that present a thin, almost blade-like, edge and conduits that are cut to size which may present sharp, serrated, or rough areas that can damage the wires.

Where possible, bushings are used during insulation. A solid ring of an appropriate size for the conduit circumference is fitted onto the end of the conduit to cover the exposed edge and present a smooth inner wall and dull lip for receiving wires and cables threaded through the conduit. This arrangement prevents the end of the conduit from presenting a cutting hazard to the wires and cables.

Situations arise when a bushing is needed for a conduit through which cables have already been run. For example, situations such as when a bushing was forgotten, or when a previously installed bushing breaks or needs to be removed. The prior art developed what are known as “split bushings” for these occurrences. Split bushings are bushings that have a cut or slit in their sidewall. The slit allows the bushing ends on each side of the slit to be pulled apart from one another wide enough to allow wires and cables to pass into the bushing's interior. The split bushing having the cables threaded therethrough, is then secured to the conduit end akin to a solid bushing and thereafter operates to protect the wires in the same manner.

As recognized by the present inventors, a drawback with prior art bushings, and split bushings in particular, is the inability to use one bushing for varying sized conduits and varying conduit types. Another drawback recognized by the present inventor is the inability to tighten or lock a split bushing in place without using external or other materials apart from the bushing. Yet another drawback recognized by the present inventor is the expense incurred to mold many prior art plastic split bushings.

The foregoing highlights some of the problems with conventional spit bushings as recognized by the present inventors. Furthermore, the foregoing highlights the present inventors' recognition of a long-felt, yet unresolved need in the art for a split bushing capable of being permanently installed. In addition, the foregoing highlights the inventors' recognition of a need in the art for a split bushing capable of use with varying conduit types. Finally, the foregoing highlights the present inventors' recognition of the need for a cost effective plastic molded split bushing that overcomes the problems in the art.

### SUMMARY OF THE INVENTION

Various embodiments of the present invention overcome various of the aforementioned and other disadvantages associated with prior art split bushings and offers new advantages as well.

According to one aspect of various embodiments of the present invention, there is provided a split bushing including a hinge. In accordance with this aspect, some embodiments of the invention include a “living hinge.” A presently preferred living hinge comprises a thinned area in the bushing opposite the sidewall split. More preferably, the bushing comprises plastic and the living hinge is a thin area of plastic configured to allow the bushing to bend in an open position. An advantageous feature of this embodiment is the ability to mold the split bushing including a living hinge as one continuous part.

According to another aspect of various embodiments of the present invention, there is provided a split bushing having a tightening mechanism. In accordance with this aspect, some embodiments of the invention include a means for connecting each of the ends of the bushing at the slit. A presently preferred embodiment of the connecting means comprises a male tongue with locking ridges on a first end and a female receiving orifice on the second end. More preferably, the male ends ridges are configured to provide a “one-way” matting with the female end.

As will be appreciated, similar to zip ties, the male end's ridges, or teeth, are profiled with an inclined surface to cam into the catch and then be blocked from being pulled out in the opposite direction by a vertical face. Thus, the male end may be threaded further into the catch and reduce the circumference of the bushing and tighten the bushing in place. Likewise, the length of the tongue allows for the bushing to be placed around conduits that have a circumference larger than the circumference of the bushing in the fully closed position. An advantageous feature of this embodiment is the ability to mold the split bushing including the tightening mechanism as one continuous part.

The invention as described and claimed herein should become evident to a person of ordinary skill in the art given the following enabling description and drawings. The drawings are for illustration purposes only and are not drawn to scale unless otherwise indicated. The drawings are not intended to limit the scope of the invention. The following enabling disclosure is directed to one of ordinary skill in the art and presupposes that those aspects of the invention within the ability of the ordinarily skilled artisan are understood and appreciated.

As used in this application, the terms “front,” “rear,” “upper,” “lower,” “upwardly,” “downwardly,” and other orientational descriptors are intended to facilitate the description of the exemplary embodiment of the present invention, and are not intended to limit the structure of the exemplary embodiment of the present invention to any particular position or orientation.

### BRIEF DESCRIPTION OF THE DRAWINGS

Various aspects and advantageous features of embodiments of the present invention will become more apparent to those of ordinary skill when described in the detailed description of a preferred embodiment and reference to the accompany drawing wherein:

FIG. 1 is a perspective view of a prior art split bushing being deployed on a conduit,

FIG. 2 is a right, perspective view of a split bushing in the closed position according to an embodiment of the invention.

FIG. 3 is a top view of the split bushing of FIG. 2.

FIG. 4 is a right, perspective view of a split bushing in a partially closed position according to an embodiment of the invention.

FIG. 5 is a top view of the split bushing of FIG. 4.

FIG. 6 is a top view of a split bushing in the open position according to an embodiment of the invention.

FIG. 7 is a bottom view of the split bushing of FIG. 6.

FIG. 8 is an elevated, right perspective view of the split bushing of FIG. 6.

FIG. 9 is a bottom, right perspective view of the split bushing of FIG.6.

FIG. 10 is a bottom, left perspective view of the split bushing of FIG. 6.

Throughout the drawings, like reference numerals will be understood to refer to like parts, components and structures.

### DETAILED DESCRIPTION

While the present invention will be described in connection with embodiments of a plastic split bushing for 3-4 inch metal conduits, it will be readily apparent to one of ordinary skill in the art armed with the present specification that the present invention can be modified and applied to any suitable bushing, device, or the like with any suitable conduit or work piece in any suitable environment.

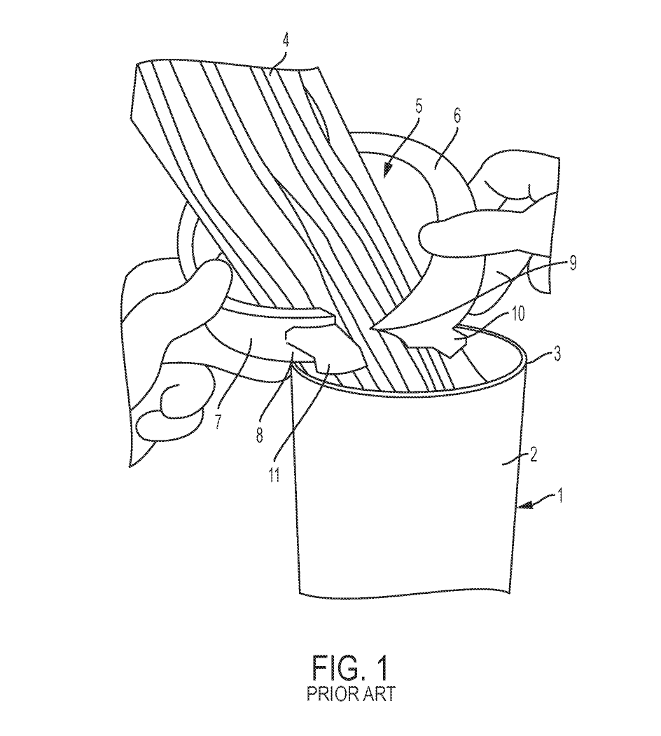

For context, a scenario wherein a prior art plastic split bushing is to be deployed is depicted in FIG. 1. As shown, a metal conduit 1 includes a sidewall 2 defining a tube having a top edge 3 that poses a cutting threat to a bundle of wires 4 passing through the conduit 1. A plastic split bushing 5 includes a top channel 6 formed by a bend in a sidewall 7 extending from a bottom outside edge 8. The sidewall 7 includes a slit 9 along its length.

As depicted the slit 9 is slanted instead of straight up and down the sidewall. With this configuration, the slit 9 in the bushing 5 may be opened by a user pulling in opposite sides of the slit 9 in opposite directions against the normally closed bias of the plastic material. Once opened a sufficient amount, the bushing 5 is maneuvered to accept the wires 4 in its interior and then positioned to be mounted on the top edge 3 of the conduit 1 as shown in FIG. 1

The bushing 5 is pushed down until the top edge 3 of the conduit 1 is seated in the channel 6 of the bushing 5. The right 10 and left 11 extensions in the slit 9 area are pushed together to close the bushing 5. The bushing 5 now covers the entire circumferential edge of the conduit 1.

As will be appreciated, the prior art split bushing 5 is not locked into place absent the use of a separate closure to clamp the right 10 and left 11 extensions in a pinched, or closed, position. Depending on the conduit type, the channel may be a loose of snug fit. Loose fitting bushings are susceptible to being dislodged. As will also be appreciated, the prior art split bushing 5 is limited in the amount the slit 9 can be spread open without concern of breaking or over-stretching the plastic body.

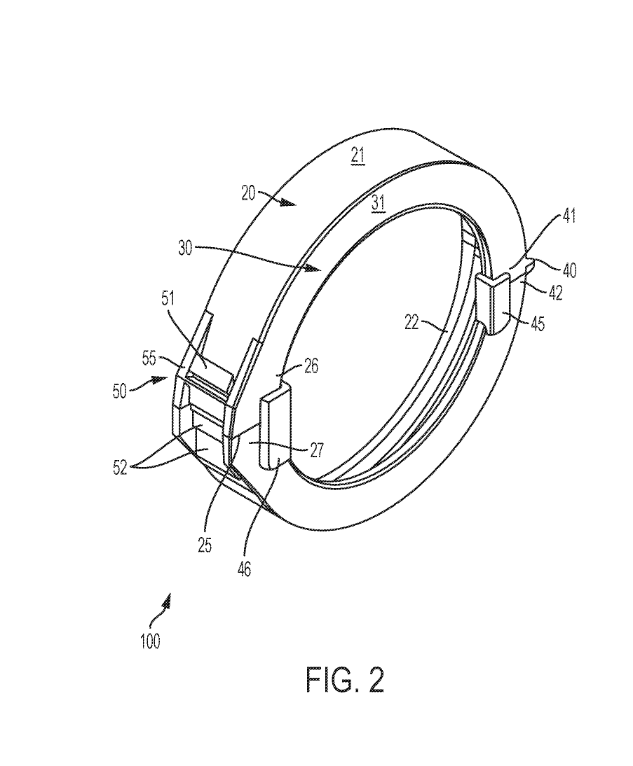

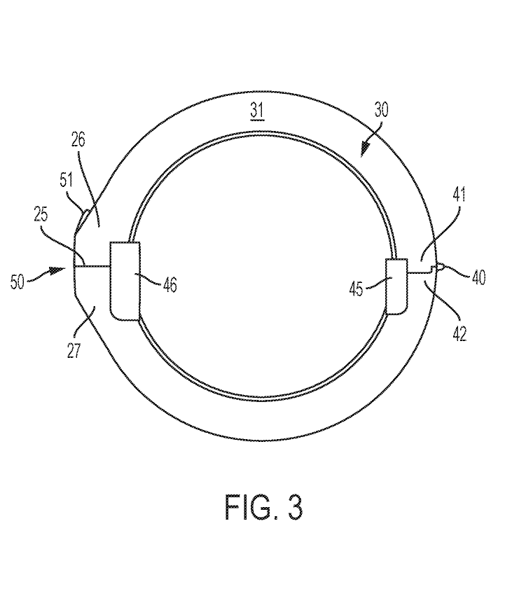

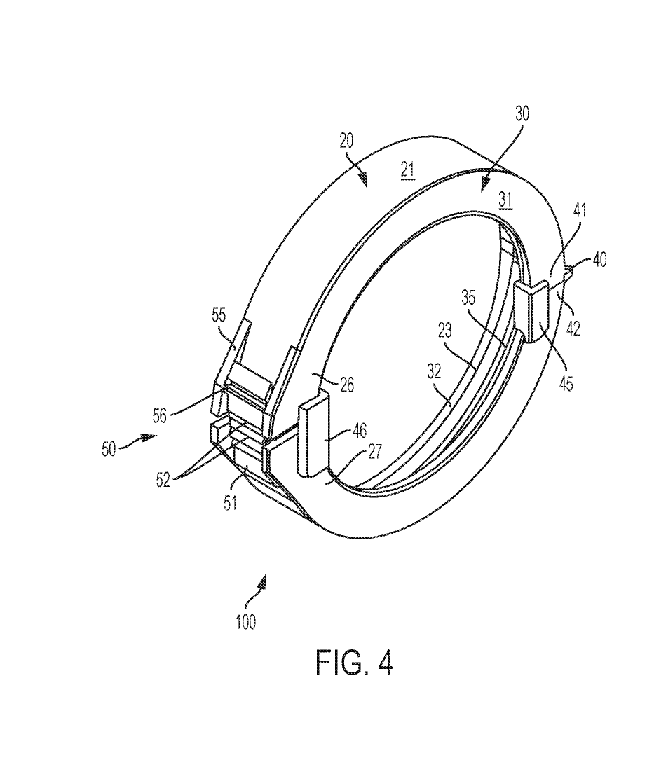

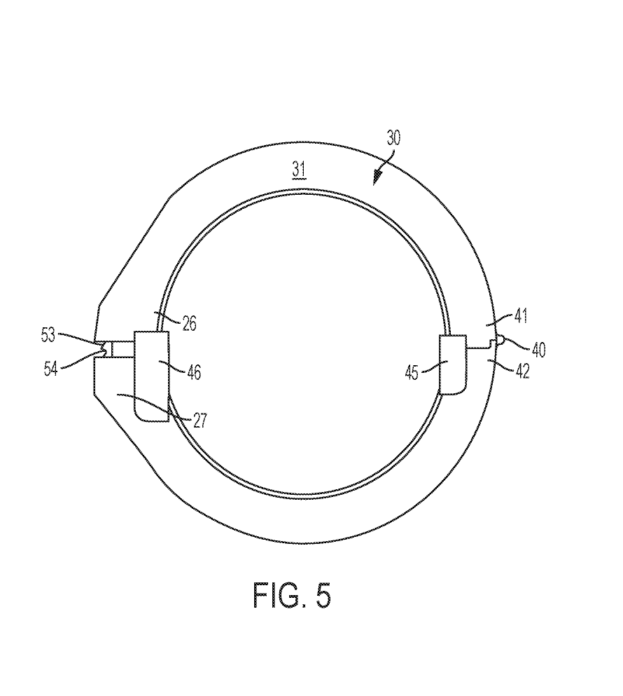

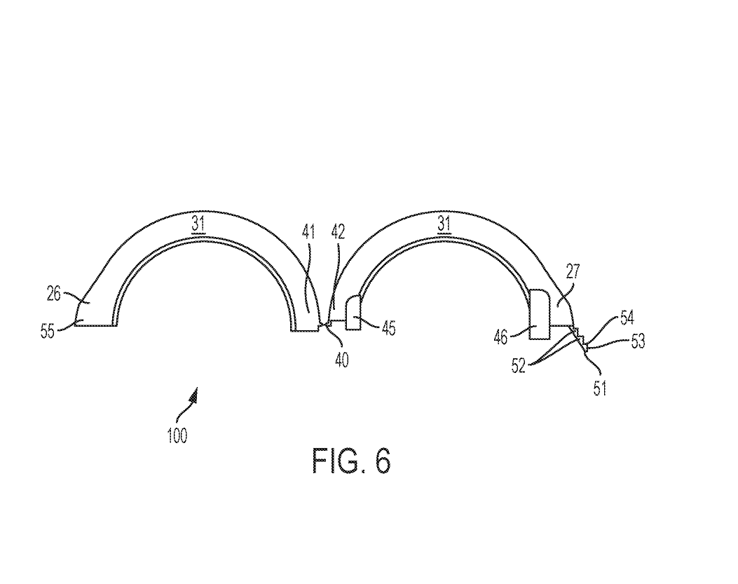

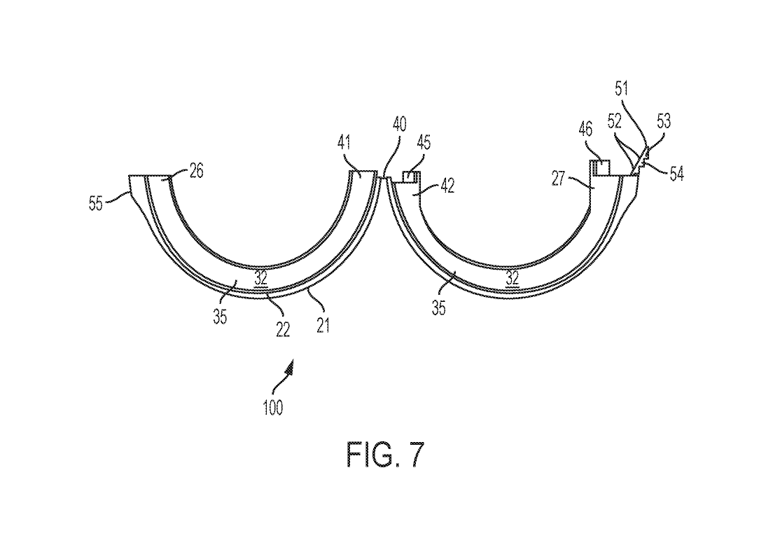

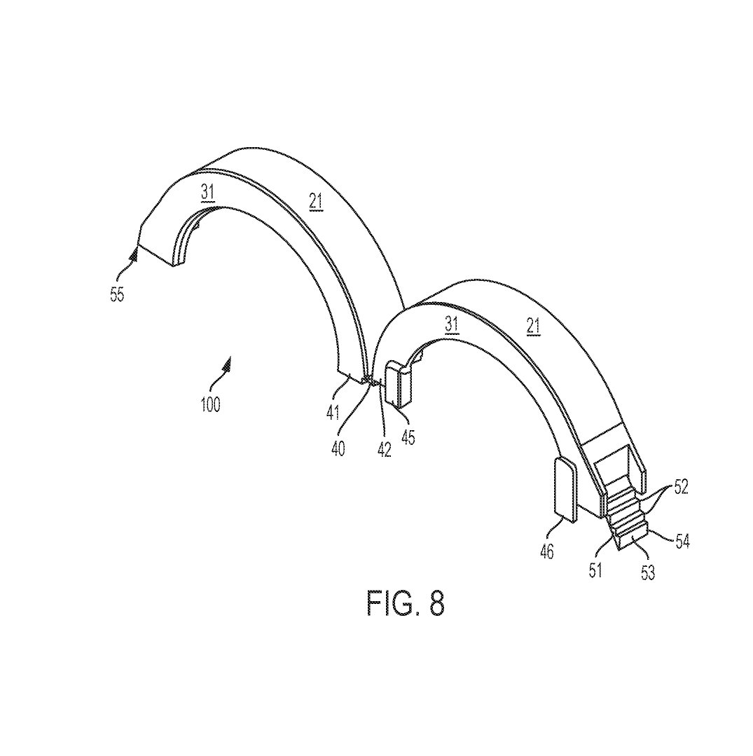

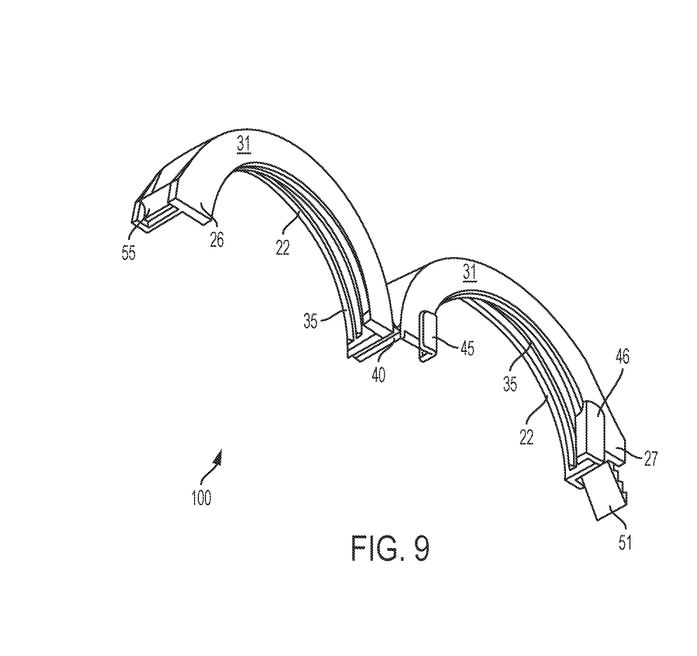

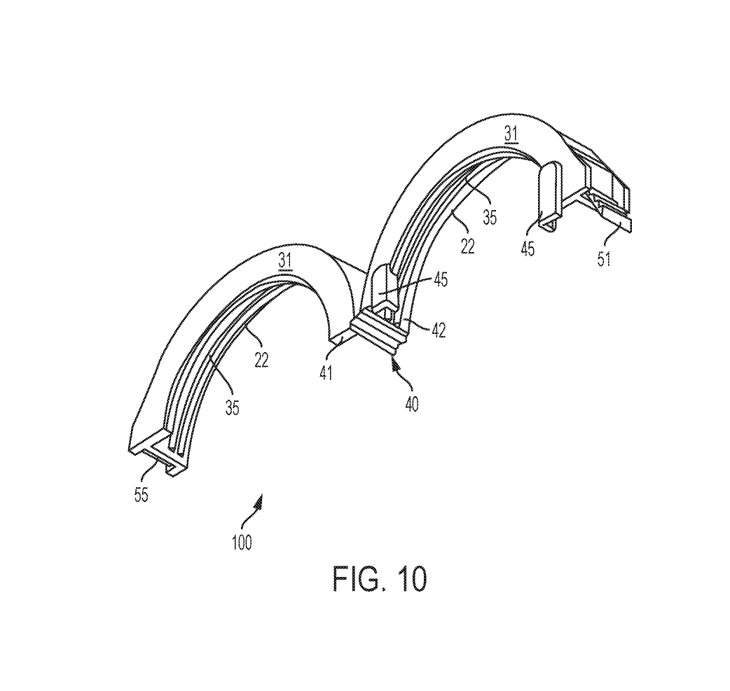

As discussed herein below, a presently preferred embodiment exemplifying aspects of the present invention provides improvements over prior art bushings. As shown in FIGS. 2-10, a split bushing 100 in the form of a unitary plastic casting comprises a body having a sidewall 20 including an outside surface 21 and an inside surface 22. The inside surface may further define threads 23 for receiving threaded conduits. The threads 23 may be full threads for threaded conduits and connections, or “partial” threads that aid the tightening and securing of the bushing to a smooth conduit.

The sidewall continues from a bottom edge 24 through a top rim 30 and includes a longitudinal slit 25 or “split” that allows the bushing 100 to be opened to receive wires 4 passing through a conduit 1. The top rim 30 includes a top surface 31 and an inside surface 32 and is of a thickness sufficient to define an inner channel 35 for receiving the outer edge 3 of a conduit 1.

The bushing 100 includes a hinge 40 at an area directly opposite the longitudinal slit 25. The longitudinal slit 25 in conjunction with the hinge 40 can be viewed as dividing the bushing 100 into a left arm 26 and a right arm 27 terminating at the hinge 40 with a left end 41 and a right end 42. The hinge 40 is a “living hinge” comprising a thin area configured to allow the left arm 26 and right arm 27 to be pulled in opposite directions to open the slit 25. In the embodiment shown, the living hinge 40 is a thinned walled area having an interiorly disposed triangular cutout. This configuration allows the hinge to be molded in the open (nearly 180 degrees or more) position so it can be opened and closed without compromising the integrity of the material by over-stretching the hinge area during closure. Alternatively, the bushing can be molded in the closed position and the hinge configured to allow the arms to be pulled apart without compromising the integrity or over-stretching the hinge area during use.

As shown, the living hinge 40 is flanked by a left end 41 and a right end 42 of the bushing 100. When rotated into the closed position, the left end 41 and right end 42 nest in a back clasp 45. Similarly, in the embodiment depicted in the Figures, the left arm 26 and right arm 27 when rotated in the closed position may nest in a front clasp 46. The clasps 45, 46 may be configured as U-shaped channels for receiving the leading edges of the top rim 30 at the meeting points 26, 27 and 41, 42.

The bushing 100 preferably includes an integrally formed locking mechanism 50. In the depicted embodiment, the locking mechanism 50 includes a “zip tie” type lock. Specifically, the right arm 42 includes a male tongue extension 51 and the left arm 41 includes a female catch body 55.

The catch 55 may be a channel defining an underpass through which the tongue 51 is inserted. The tongue extension 51 includes raised ridges 52. The ridges 52 are generally triangular and preferably include inclined leading surfaces 53 and vertical back surfaces 54. With this configuration, the ridges 52 cam or deflect under the top of the underpass. Once a ridge 52 passes through, the vertical surface 54 acts as a stop and prevents the tongue 51 from being retracted because it cannot slide under the underpass. The ridges 52 can only travel one-way through the channel catch 55 before being locked from being retracted.

The locking mechanism 50 provides the bushing 100 with the ability to fit different types of conduits including EMT, IMC, Rigid, or PVC conduits—including unthreaded and threaded types of each.

As shown in the Figures, and as will now be appreciated by one of ordinary skill in the art armed with the present specification, the present embodiment demonstrates the ability to use a single mold casting of a split bushing that includes a living hinge and a locking mechanism to achieve the various advantageous features realized by those aspects. Other configurations are possible, including other locking mechanisms, other hinge types, and other non-single mold casting configurations.

While advantageous embodiments have been chosen to illustrate the invention, it will be understood by those skilled in the art that various changes and modifications may be made therein without departing from the scope of the invention. The above embodiments are for illustrative purposes and are not intended to limit the scope of the invention or the adaptation of the features described herein to particular tools. Those skilled in the art will also appreciate that various adaptations and modifications of the above-described preferred embodiments can be configured without departing from the scope and spirit of the invention. Therefore, it is to be understood that the invention may be practiced other than as specifically described.

We claim:

1. A busing comprising:
a first arm and a second arm, each arm having a first end and a second end,
a hinge connecting said first arm and said second arm at said first ends of said arms;
means for connecting said second end of said first arm to said second end of said second arm; and,
wherein said first arm, said second arm, and said hinge are integrally formed.

2. The bushing of claim 1, wherein said means for connecting comprises a clasp.

3. The bushing of claim 2, wherein said clasp comprises a u-shaped channel on said first arm and a leading edge on said second arm for insertion into said u-shaped tunnel.

4. The bushing of claim 1, wherein said means for connecting comprises a tongue member on said first arm and a catch for receiving and holding said tongue member.

5. The bushing of claim 4, wherein said tongue member comprises series of raised triangular ridges for one way insertion into said catch, whereby an interior diameter of said bushing is adjustable by insertion to a given raised ridge.

6. The bushing of claim 1, wherein said hinge is configured to define a triangular cutout portion, whereby said hinge is bendable in a manner to connect said first and said second arm.

7. The bushing of claim 6, wherein said bushing is made of molded plastic.

8. The bushing of claim 7, wherein said bushing is molded in an open position.

9. The bushing of claim 7, wherein said bushing is molded in a closed position.

10. The bushing of claim 1, further comprising threads on an interior surface of said first and second arms.

11. The bushing of claim 10, wherein said threads are full threads.

12. The bushing of claim 10, wherein said threads are partial threads.

13. A hinged split bushing comprising:
a generally ringed-shaped body having being split in a terminal area;
a hinge formed on said body at an area approximately opposite said split, said hinge formed as a thin-walled area of said body; and,
a closure mechanism comprising a tongue member on a first end of said split and a tongue-receiving member on a second end of said split, whereby said bushing is bendable at said hinge to flex open to surround a material in its interior and bendable to flex closed to allow said tongue to be inserted into said tongue receiving member.

14. The hinged split bushing of claim 13, wherein said body includes a generally vertically extending sidewall having an outer surface and an inner surface, a generally vertically extending top rim formed atop said sidewall, and a generally vertically extending bottom edge formed at the bottom of said sidewall; said inner surface including threads.

15. The hinged split bushing of claim 14, wherein said threads are full threads.

16. The hinged split bushing of claim 14, wherein said threads are half thread.

17. The hinged split bushing of claim 13, wherein said tongue comprises a series of raised triangular ridges and said tongue receiving member comprises a u-shaped catch member, wherein said ridges cam under said catch and cannot back out of said catch.

18. The hinged split bushing of claim 13, wherein said hinge defines a triangular cutout.

19. The hinged split bushing of claim 13, wherein said hinged split bushing is molded as a unitary piece in the open position.

20. The hinged split bushing of claim 13, wherein said hinged split bushing is molded as a unitary piece as a generally circular casting.
